(19) United States
(12) Patent Application Publication
(10) Pub. No.: US 2014/0026764 A1
(43) Pub. Date: Jan. 30, 2014

(54) PRECISION PLATEN POSITIONING DEVICES AND METHODS FOR GRILLS

(71) Applicant: GARLAND COMMERCIAL INDUSTRIES LLC., New Port Richey, FL (US)

(72) Inventors: Michael SYKES, ORANGEVILLE (CA); Dragan MRKOVIC, NEWMARKET (CA); Paulo J. ROSA, MISSISSAUGA (CA); Douglas S. JONES, NEW PORT RICHEY, FL (US); Jan S. CLAESSON, LAND O' LAKES, FL (US)

(73) Assignee: GARLAND COMMERCIAL INDUSTRIES LLC., New Port Richey, FL (US)

(21) Appl. No.: 13/941,284

(22) Filed: Jul. 12, 2013

Related U.S. Application Data
(60) Provisional application No. 61/671,658, filed on Jul. 13, 2012.

(51) Int. Cl. A47J 37/06

(52) U.S. Cl. CPC A47J 37/06
USPC 99/349

(57) ABSTRACT

The grills of the present disclosure provide several devices and methods for ensuring that cooking platens are level and provide the correct amount of pressure when cooking a food product. In contrast to currently available cooking devices, those of the present disclosure can be automatically leveled on set up, and adjust during or after operation, thus being able to withstand unpredicted events or normal use that may knock the grills out of level.

### CROSS-REFERENCE TO RELATED APPLICATIONS

The present application claims the benefit under 35 U.S.C. §119(e) of United States Provisional Patent Application No. 61/671,658, filed on Jul. 13, 2012, which is incorporated by reference.

### BACKGROUND OF THE DISCLOSURE

1. Field of the Disclosure

The present disclosure relates to clamshell grills. More particularly, the present disclosure relates to clamshell grills having devices and mechanisms for positioning and raising a cook platen.

2. Description of the Related Art

Clamshell grills generally refer to cooking grills where food is cooked between two heated platens, one on top of the other. An important aspect of clamshell cooking is the requirement to maintain a precise, repeatable, and fixed distance between the platens during the cooking process. It is also important to place a repeatable amount of pressure on the food product that is being cooked, as this affects food quality and uniformity significantly.

In current devices, to achieve these goals, some form of manual adjustment is commonly employed. However, such manual adjustment is subject to human error and influence and variations can result. In addition, any moving mechanical system will exhibit some wear of components over its lifetime, which could cause a system that was level at the install to become out of level over time. Clamshell grills may also be subjected to a number of “physical impact” events, such as moving the units out for cleaning or physically interacting with the unit in an unintended fashion (e.g., leaning on, standing on, or pulling down on the grill). These forces will also knock the grill out of parallel alignment. The only way to address this problem currently is with a service call, which can be timely and expensive. It also requires that a machine be shut down for an extended period of time, which is unacceptable to users.

As the cantilevered platen is supported from the rear of the grill, the majority of variance will be seen when comparing the cook gap at the front portion of the platens to the gap measured at the back of the platens. Also, platens are often very heavy, as a high weight is needed to apply the proper amount of pressure to the food product.

Accordingly, there is a need for clamshell grills that can provide leveling features automatically, and which can ensure that cooking platens are consistently parallel. The present disclosure addresses these needs.

### SUMMARY OF THE DISCLOSURE

The present disclosure provides several grills and devices that allow for easy and reliable leveling of cooking platens, which overcome the aforementioned disadvantages.

In one embodiment, the present disclosure provides a grill comprising a lower heating plate, and an upper platen having a bottom surface and a top surface, wherein a food product is cooked between the bottom surface and the lower heating plate. The grill further comprises a lever connected to the top surface of the upper platen, a motor connected to the lever and the top surface of the upper platen, and a lead screw operably connected to the motor. A vertical position of the upper platen is adjusted when the motor acts on the screw.

In another embodiment, the present disclosure provides a grill, comprising an upper platen and a cook surface, wherein a food product is cooked between the upper platen and the cook surface. The grill further comprises a rotary actuator and a multi-bar linkage system. The rotary actuator is connected to the upper platen through the multi-bar linkage system. The rotary actuator lowers and raises the upper platen in a direction toward and away from the cook surface.

In another embodiment, the present disclosure provides a grill comprising a cooking surface, an upper platen, a first horizontal vertical member connected to a top surface of the upper platen, a horizontal member having a first end connected to the first horizontal member, a pivot about which the horizontal member rotates, a second vertical member connected to a second end of the horizontal member; and an actuator operably connected to the second vertical member. The actuator selectively moves the second vertical member up and down, thereby causing the horizontal member to rotate about the pivot, and in turn adjusting a vertical height of the upper platen with respect to the cooking surface.

In another embodiment, the present disclosure provides a grill comprising a cooking surface, an upper platen, and a skeleton frame connected to a top surface of the upper platen, so that the upper platen can move in a vertical direction with respect to the skeleton frame. The grill further comprises a locking mechanism connected to the skeleton frame, for locking the skeleton frame in a vertical position, and a control system. The control system moves the upper platen in a vertical position with respect to the cooking surface, when the skeleton frame is locked in position by the locking mechanism.

### BRIEF DESCRIPTION OF THE DRAWINGS

FIG. 1 shows a top, perspective view of a first embodiment of the grill of the present disclosure;

FIG. 2 shows a side view of the grill of FIG. 1;

FIG. 3 shows a top, perspective view of a second embodiment of the grill of the present disclosure;

FIG. 4 shows a side view of the grill of FIG. 3;

FIG. 5 shows a top, perspective view of a third embodiment of the grill of the present disclosure;

FIG. 6 shows a side view of the grill of FIG. 5, with the platen in an elevated position;

FIG. 7 shows a side view of the grill of FIG. 5, with the platen in a horizontal position;

FIG. 8 shows a top, perspective view of a fourth embodiment of the grill of the present disclosure;

FIG. 9 shows a side view of the grill of FIG. 8, with the platen lowered to the grill surface;

FIG. 10 shows a side view of the grill of FIG. 8, with the platen raised away from the grill surface;

FIG. 11 shows a side view of the grill of FIG. 8, with the platen and retractor raised away from the grill surface;

FIG. 12 shows a top, perspective view of a fifth embodiment of the grill of the present disclosure;

FIG. 13 shows a second top, perspective view of the grill of FIG. 12;

FIG. 14 shows a third, top perspective view of the grill of FIG. 12, with the upper platen in a horizontal position;

FIG. 15 shows a fourth, top perspective view of the grill of FIG. 12, with the upper platen in a horizontal position;

FIG. 16 shows a first view of the locking mechanism of the grill of FIG. 12;

FIG. 17 shows a second view of the locking mechanism of the grill of FIG. 12;

FIG. 18 shows a first side view of the grill of FIG. 12, with the platen in an elevated position;

FIG. 19 shows a close-up of the view of FIG. 18;

FIG. 20 shows a second side view of the grill of FIG. 12, with the platen in a horizontal position;

FIG. 21a shows a side view of a sixth embodiment of the grill of the present disclosure;

FIG. 21b shows a top view of the yokes of the grill of FIG. 21a;

FIG. 21c shows a side view of the yokes of the grill of FIG. 21a;

FIG. 22 shows a top, perspective view of a seventh embodiment of the grill of the present disclosure;

FIG. 23 shows a second top, perspective view of the grill of FIG. 22;

FIG. 24 shows a side view of the grill of FIG. 22;

FIGS. 25a and 25b show views of the locking mechanism of the grill of FIG. 22;

FIG. 26 shows a top, perspective view of an eighth embodiment of the grill of the present disclosure; and

FIG. 27 shows a side view of the grill of FIG. 26.

### DETAILED DESCRIPTION OF THE DISCLOSURE

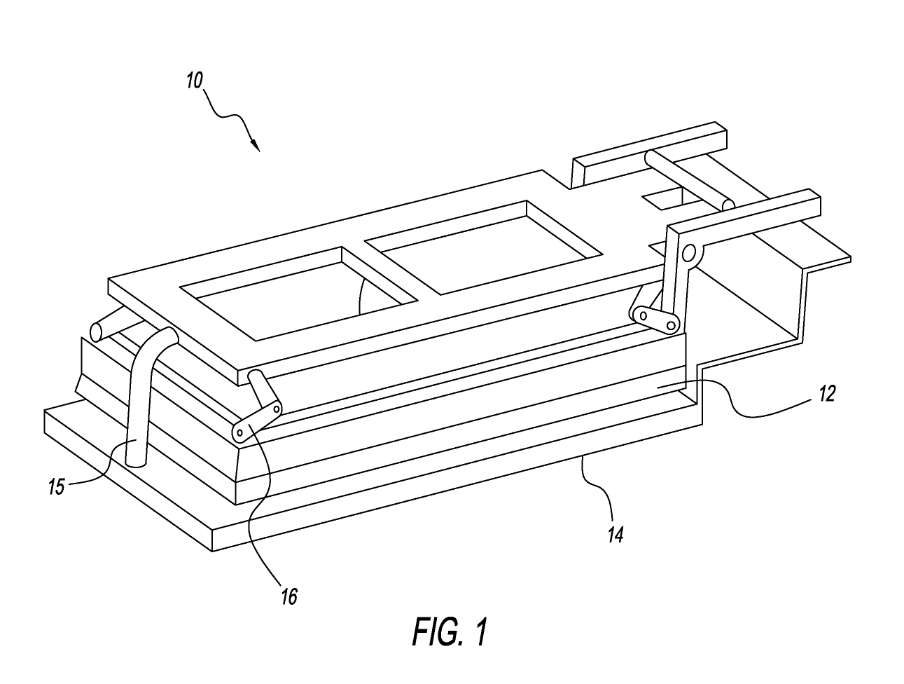

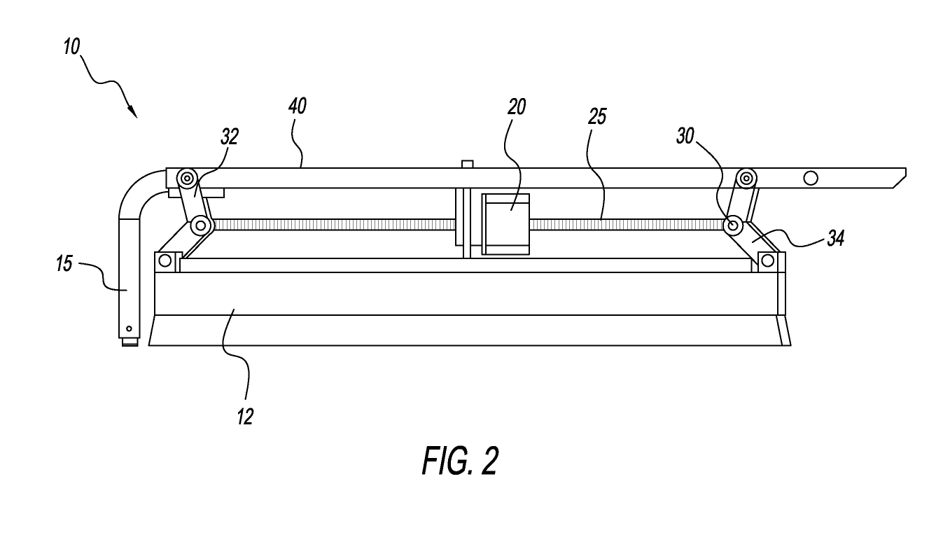

Referring to the drawings, and in particular FIGS. 1-2, a first embodiment of the grill of the present disclosure is shown. Grill 10 has upper platen 12, and lower platen 14. Grill 10 employs a scissor lift system to raise or lower upper platen 12. Grill 10 further comprises a motor 20 (with or without a gearbox), that drives lead screw 25. Lead screw 25 passes through two trunnions 30, that are at opposite ends of lead screw 25. Trunnions 30 would be restrained, to eliminate the potential for rotation. Lead screw 25 is restrained against any linear motion, and is only allowed to rotate.

Trunnions 30 each have upper links 32 and lower links 34. Upper links 32 connect trunnions 30 to an upper level 40, the latter of which is horizontal and generally parallel to platens 12 and 14. A foot or platen beam 15 is connected to a front end of level 40. When upper platen 12 is lowered into cooking position, beam 15 can contact lower platen 14, supporting upper platen 12 and minimizing any sagging or unevenness between a front and back of platen 12 and level 40.

Lower links 34 connect trunnions 30 to a top surface of upper platen 12. Since lead screw 25 is restrained, turning screw 25 results in a horizontal movement of each of trunnions 30, away from motor 20. Once beam 15 contacts lower platen 14, supporting upper platen 12 and level 40, and as trunnions 30 are pushed out, it results in a balanced rotation or expansion of links 32 and 34, resulting in a net vertical movement of upper platen 12. The pitch of lead screw 25 could be altered to control the precision of the movement. One or more sensors (not shown) located around the periphery of upper platen 12 can detect when upper platen 12 is in the proper position, and whether it is level, and send signals back to motor 20, or a controller (not shown) that operates motor 20. Each of trunnions 30 can be operated independently, if needed.

One way to level platen 12 is with an eccentric cam attachment 16, such that the eccentric cam could be rotated, thus raising or lowering the front of platen 12 and level 40 to a parallel position during a set up or installation. An additional option would be to have two motors 20 and two screws 25, thus not only providing leveling capability, but also allowing for “auto leveling” capability.

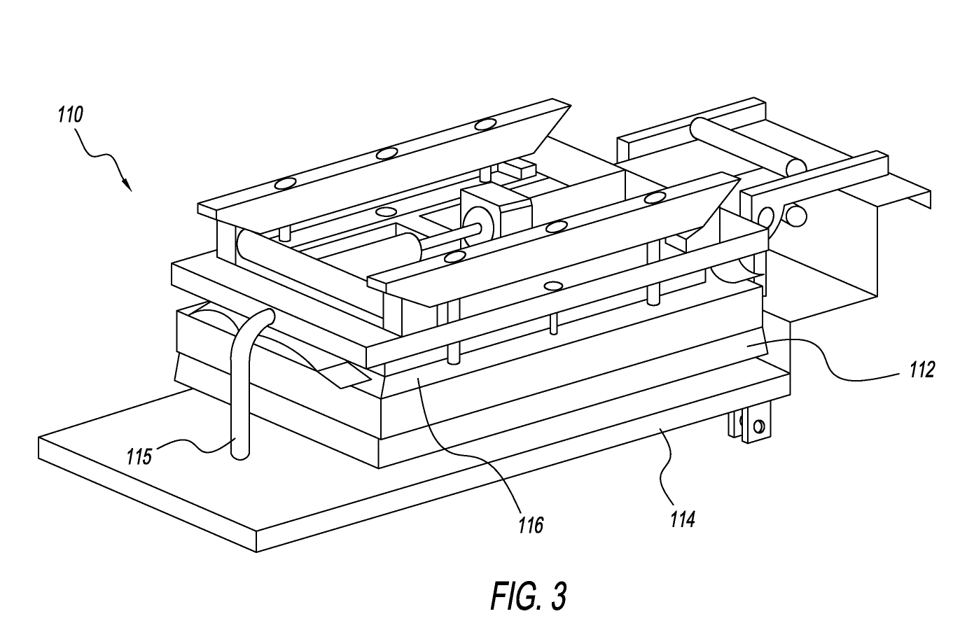

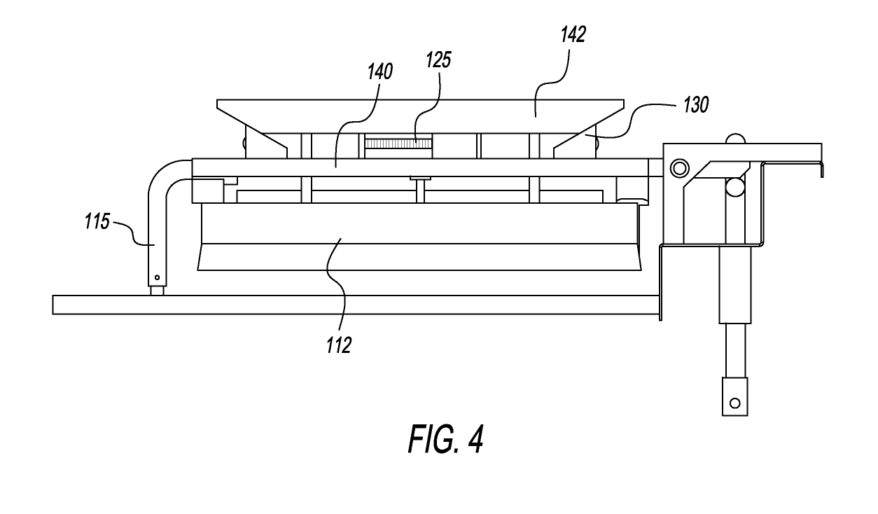

Referring to FIGS. 3-4, grill 110 is shown. Grill 110 operates on a similar principle as grill 10, with the exception that lead screw 125 of grill 110 pushes wedges 130 (as opposed to trunnions 30) in a direction away from motor 120, to force upper platen 112 downward. Arm 140 has wedges 142 at opposite ends thereof that conform to the shape of platen wedges 130. Thus, when motor 120 drives lead screw 125, wedges 130 move horizontally, and slide against platen wedges 142, to force platen 112 downward. Grill 110 also has beam 115, which functions in a similar manner to beam 15 of grill 10.

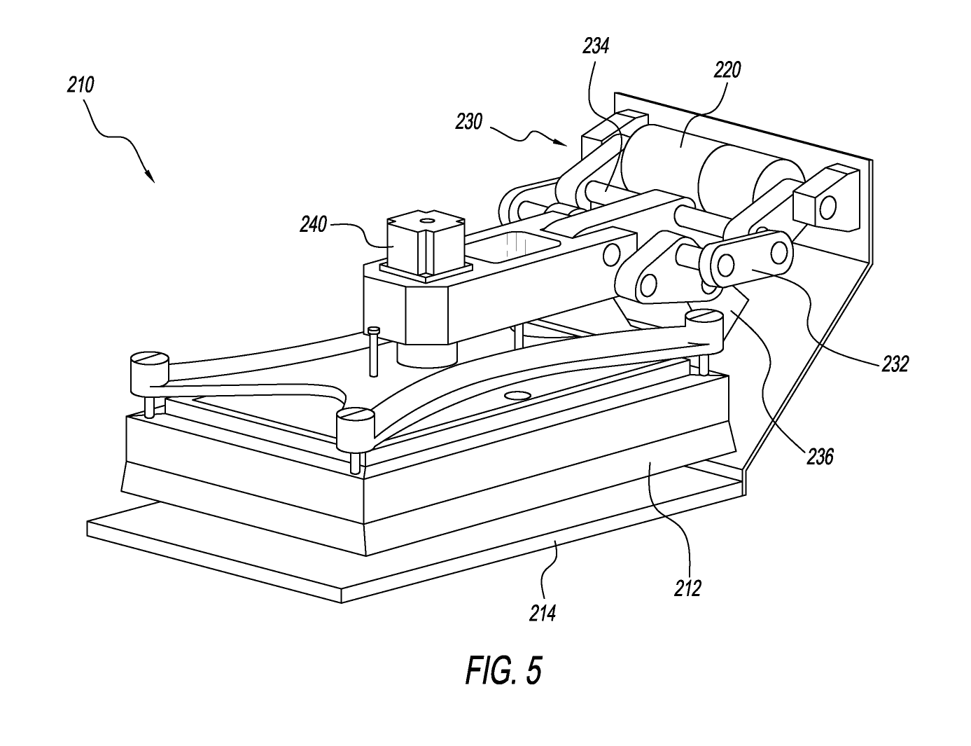

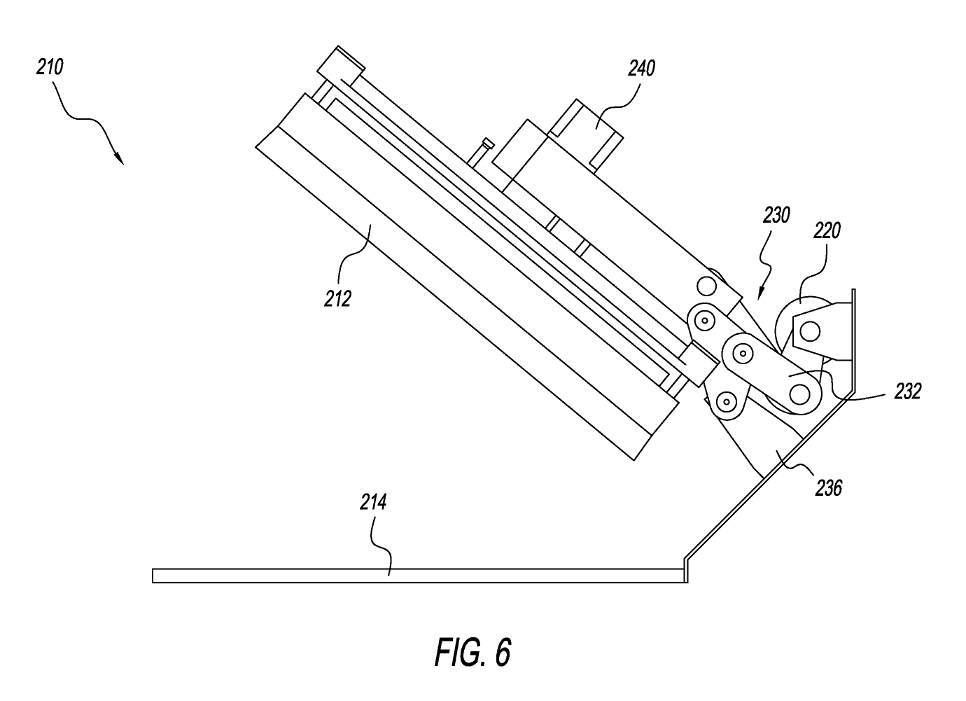

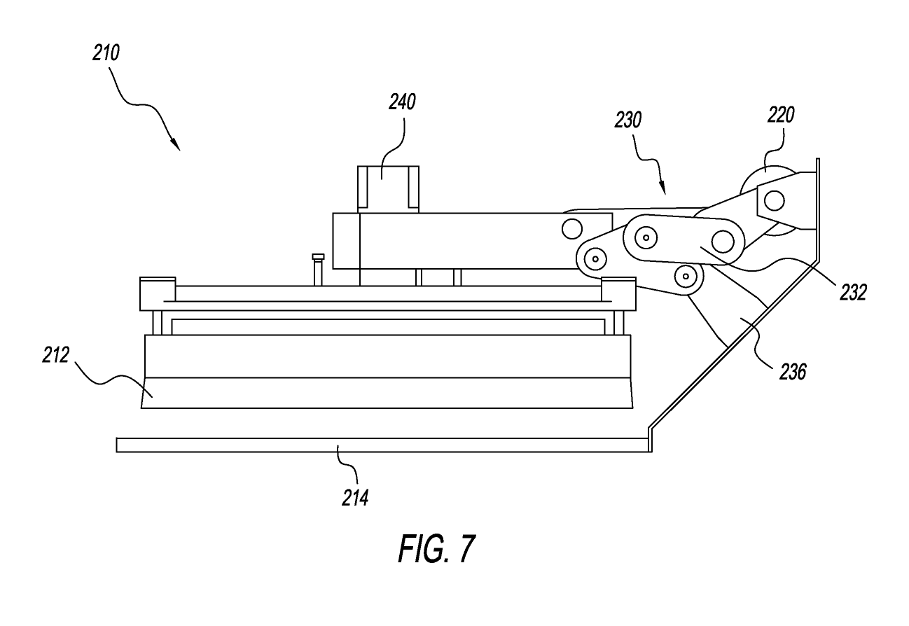

Referring to FIGS. 5-7, grill 210 is shown. Grill 210 has upper platen 212, cook surface 214, rotary actuator 220, multi-bar linkage system 230, and stepper motor 240. In grill 210, platen 212 is raised or lowered from a ready state to a cook state by multi-bar linkage system 230. Moving from the “ready” state, as shown in FIG. 6, to the “cook” state, as shown in FIG. 7, actuator 220 rotates in a counter-clockwise when viewed from the left side, as shown in FIGS. 6 and 7. System 230 has a plurality of linkages 232, a horizontal arm 234, and a plurality of mounts 236 that are permanently affixed to the wall or backsplash in the environment where grill 220 is used. Arm 234 is operably connected to platen 212.

When actuator 220 rotates in a clockwise direction from the ready state shown in FIG. 6, it pushes arm 234 away from itself, lowering platen 212 to the cook position, as shown in FIG. 7. Stepper motor 240 can then drive platen 212 further down toward cook surface 214. The desired height of platen 212 can be based on the food product to be cooked, and this information can be stored in a controller (not shown) operating stepper motor 240 and/or actuator 220. Rotating actuator 220 further in a clockwise direction past the orientation shown in FIG. 7 will allow for further adjustment of platen 212, for example to correct any sensed discrepancies in the level of platen 212. Rotating actuator 220 back in a counter-clockwise direction will bring platen 212 back into the ready position shown in FIG. 6.

Although when being raised from the cooking position, the initial motion of arm 234 is predominantly vertical, it is not only vertical. Platen 212 does tilt from front to back. Grill 210 uses this motion as a means of allowing for a front to back platen adjustment. As stated above, the adjustment of platen 212 in this fashion can be made through a motor control algorithm and a slight actuation of actuator 220. In another embodiment, the same adjustment could also be made via a manual adjustment of linkage system 230, causing the same rotational motion and adjustment. Once in the cook, or lowered position, and properly leveled from front to back, second stepper motor is used in this embodiment to impart a downward vertical motion of the platen to a desired cook gap between the lower grill surface and upper cook surface

Other benefits of grill 210 include the fact that rotary actuator 220 eliminates the need for the long linear shafts of current devices. With the shafts eliminated, so too are the holes for the shafts to pass through the backsplash, which increases the grease migration resistance path of the grill. In addition, in grill 210 all of the components necessary for platen motion are easily mounted above the backsplash as illustrated. This easily facilitates the use of such a mechanism for a counter top design of grill.

In grill 210, the lift path of platen 212 can be easily customized based on user preference or the needs of the surrounding environment. Linkage system 230 can also be self-locking, to enable force cooking. Actuator 220 can be mounted above and behind platen 212, or alternatively hidden within a cavity (not shown) of grill 210.

Current grill units have a working height of around 30″ above the floor (e.g., from the bottom of the surface of plate 214 to the floor). The 30 inches below the grill plate currently house the platen lift mechanism, which is essentially a vertical structure. The depth of this lift structure, and the need to house the electronics to operate the grill, restricts these units to be “floor mount” appliance, meaning it rests on the kitchen floor. Grill 210, by contrast, eliminates this vertical lift structure, and mounts all of the lift components necessary above the surface of plate 214. In one embodiment, the required electronics could be packaged under plate 214 within a 14″ envelope. The resulting package could now be considered “countertop”, meaning that it could sit on a counter, stand, or refrigeration equipment, still yielding a 30″ working surface. It is conceivably even possible to mount the lift mechanism, platen assembly, and required electronics on to an existing “flat grill”. These advantages are significant over currently available designs, and could present new applications for grill 210.

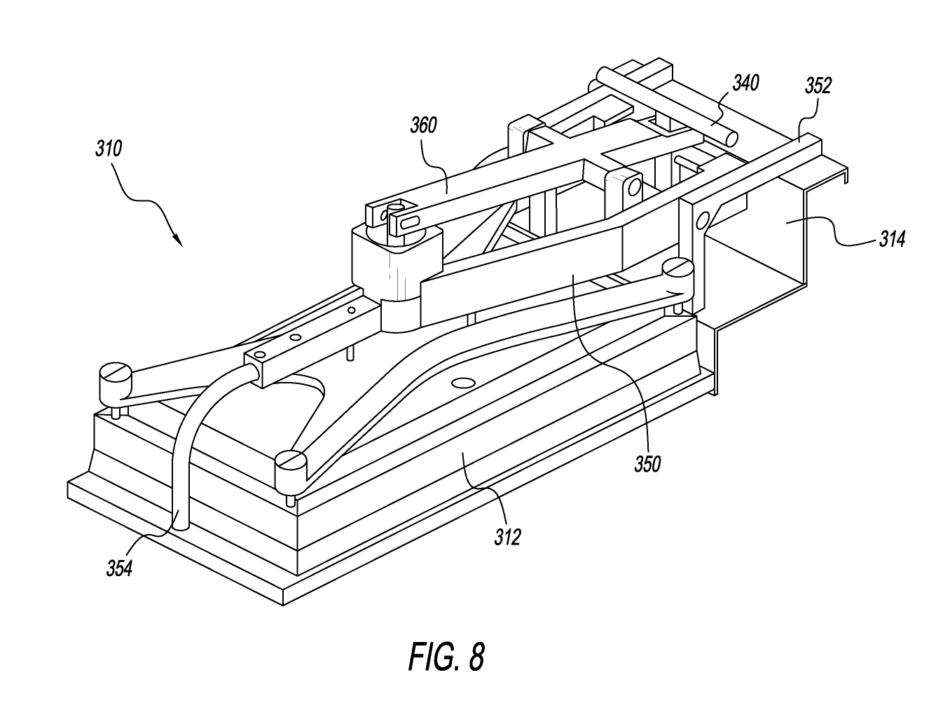

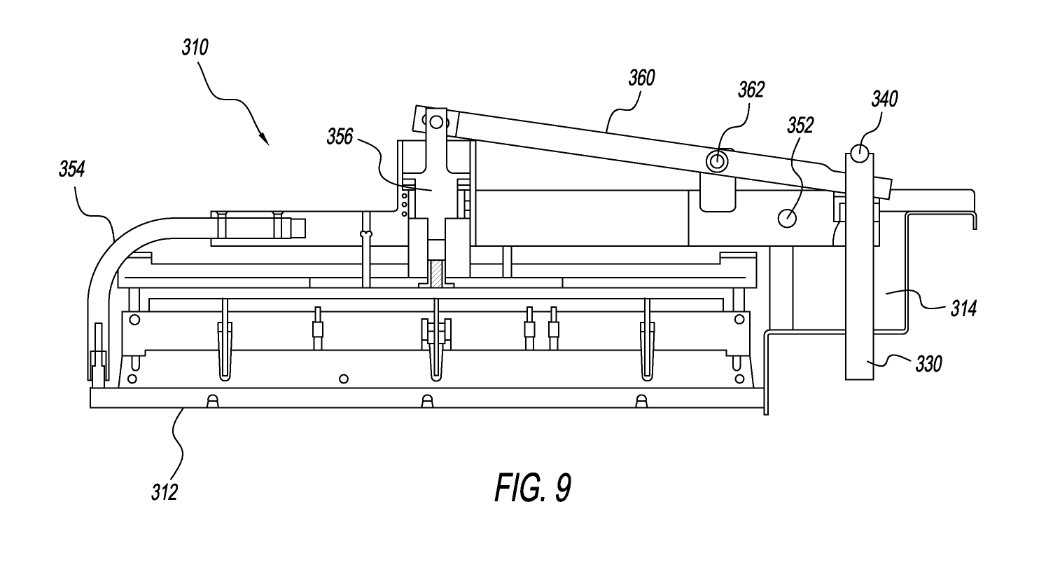

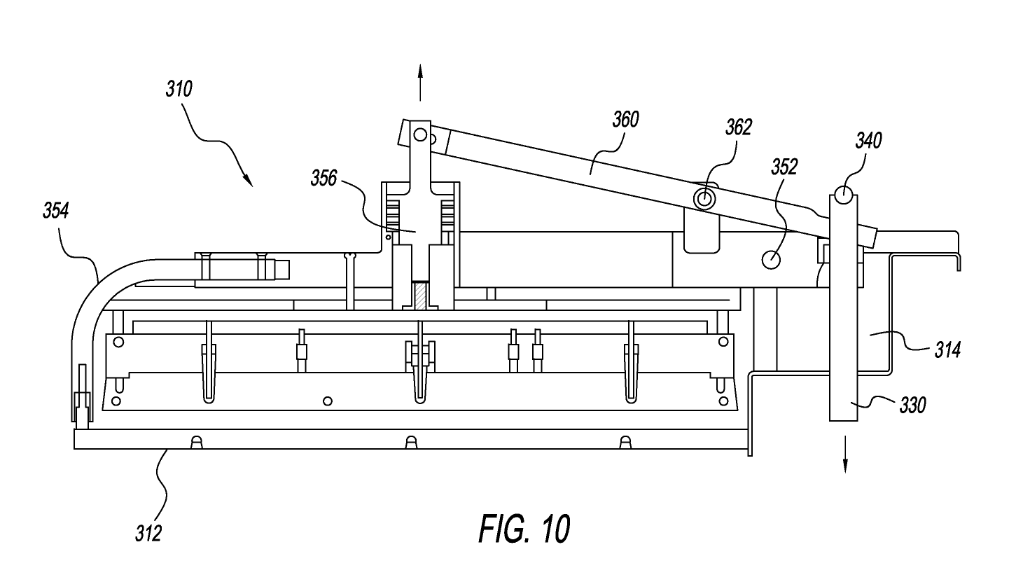

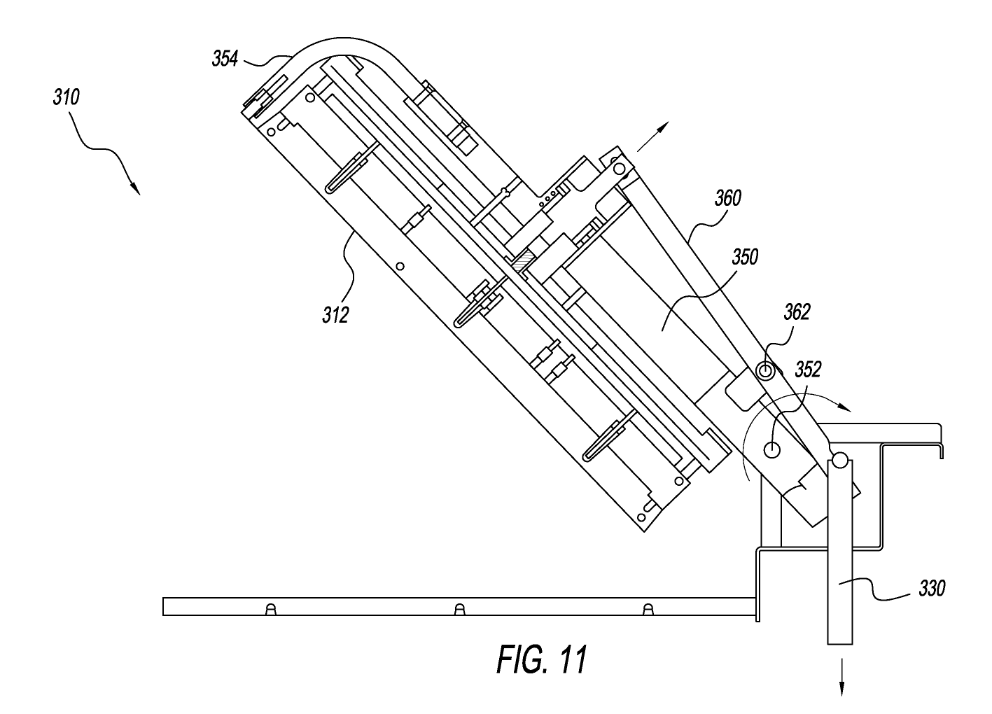

Referring to FIGS. 8-11, grill 310 is shown. Grill 310 provides an embodiment in which the final vertical movement of a platen 312 to its desired cook gap setting is controlled by an actuator (not shown). Grill 310 comprises a single vertical member 330, an upper horizontal member 340, a lower horizontal member or arm 350, and a platen lever 360. Platen 312 is suspended from arm 350, and arm 350 pivots on an arm pivot 352 that is rigidly affixed to chassis 314 of grill 310 as illustrated. When the actuator is fully retracted, it pulls vertical member 330 downward. Upper horizontal member 340 will contact platen lever 360 and arm 350, forcing a rotation of arm 350 about pivot 352 and in turn raising platen 312. When the actuator is extended, upper horizontal member 340 raises, allowing arm 350 to rotate with gravity in a counter-clockwise direction, thus lowering platen 312 to a position required to facilitate cooking. A reference bar 354 is affixed to the front of arm 350, and bar 354 will eventually come to rest on the grill surface itself, thereby stopping any further rotation of arm 350, even though upper horizontal member 340 of the shaft will eventually lose contact with arm 350.

The movement of the platen relative to the arm is controlled through the actuation of platen lever 360. Platen 312 is restrained to only allow for parallel motion either closer to or away from arm 350 through a guided shaft 356 that is perpendicular to arm 350. One end of shaft 356 is attached to platen lever 360, and the other end is supported between upper and lower horizontal members of the shaft assembly. Platen lever 360 is pivotally attached to arm 350, as illustrated. Movement of the actuator and in turn vertical member 330 allows platen lever 360 to rotate about its pivot point 362 on arm 350, arm causing platen 312 to raise or lower relative to the arm.

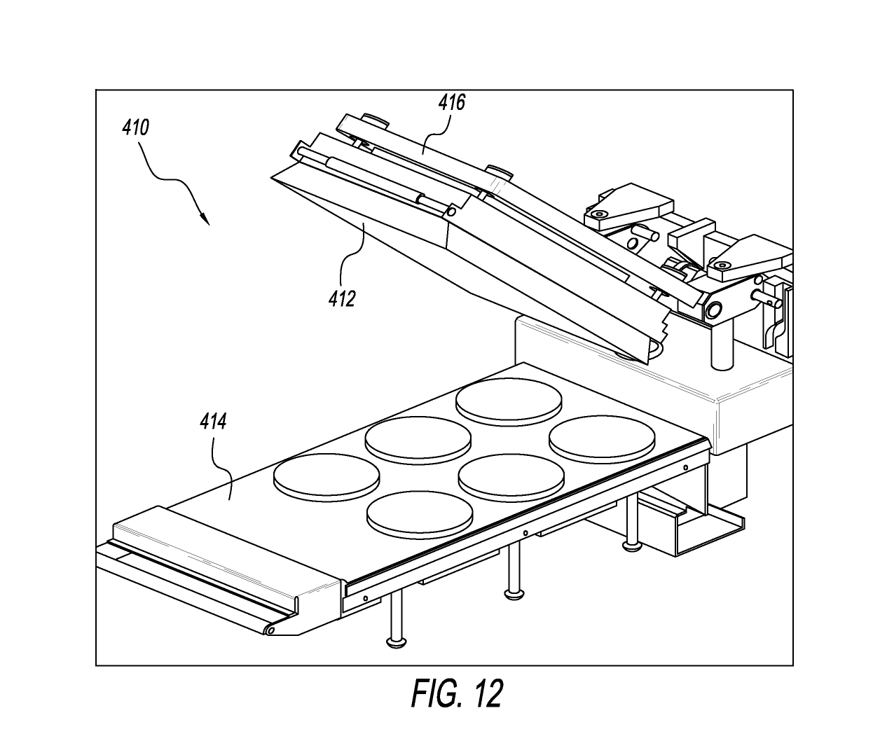

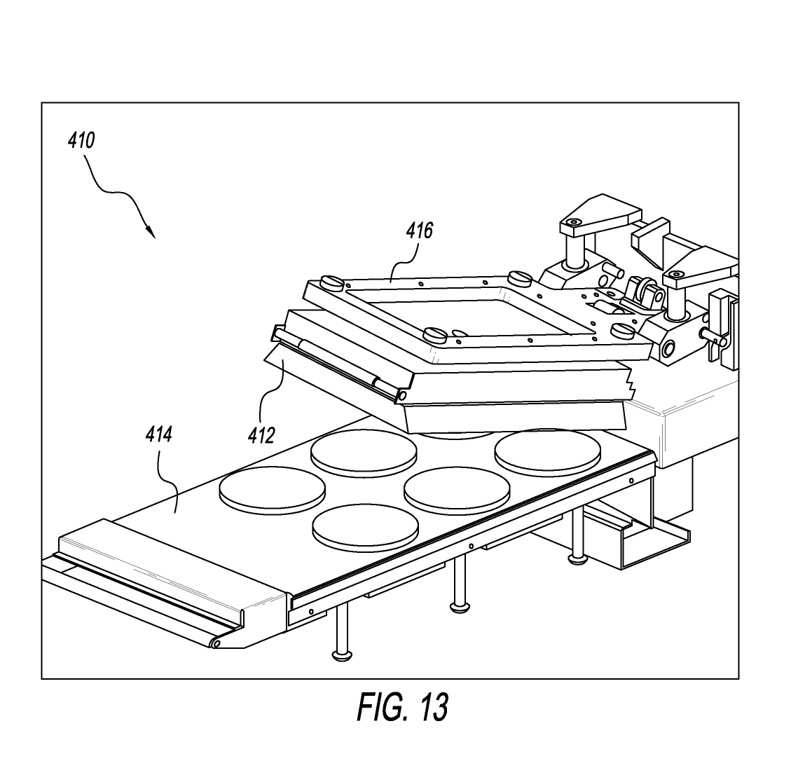

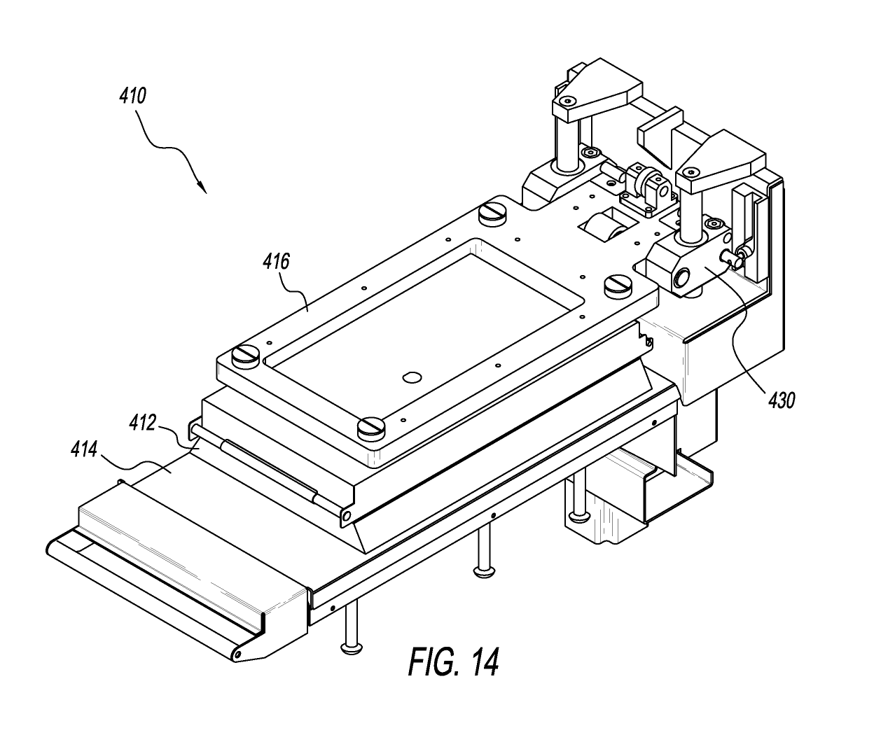

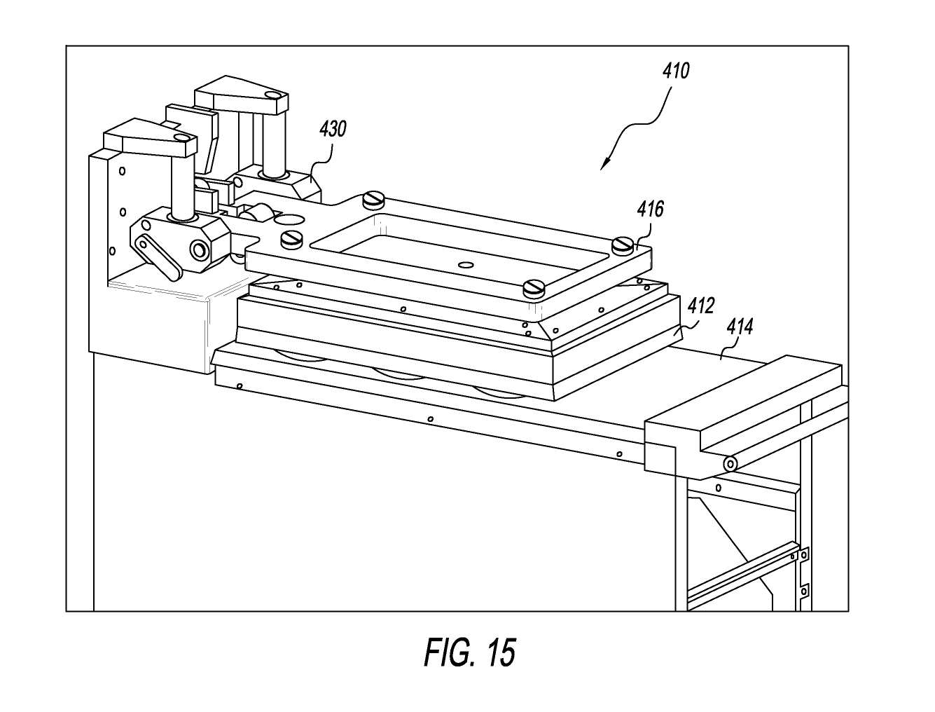

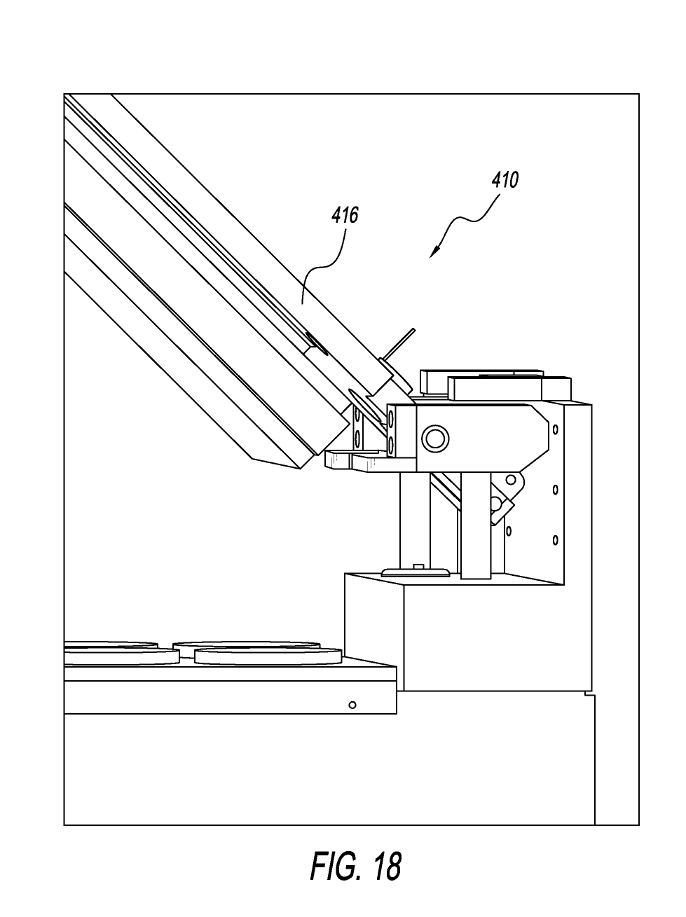

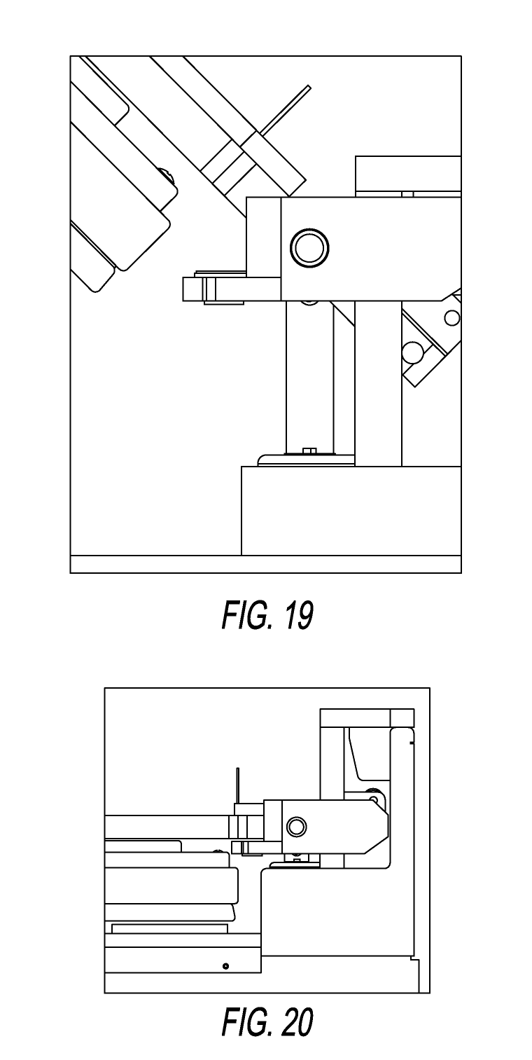

Referring to FIGS. 12-20, grill 410 is shown. Grill 410 has upper platen 412, and lower cooking surface 414. A control system (not shown) can move upper platen 412 from a first, non-cooking position, which is not parallel to lower cooking surface 414, to a second, lower position that is parallel to lower cooking surface 414. In this second position, the skeleton structure 416 (shown in FIG. 13 and described in further detail below), to which upper platen 412 is connected, can be locked parallel to lower cooking surface 414. The control system can then move upper platen 412 further downward into a third position, where platen 412 makes contact with food on lower cooking surface 414, or into a fourth position, where platen 412 makes contact with lower cooking surface 414 itself.

If there is food on lower cooking surface 414, the controller stops the movement of upper platen 412. Platen 412 can move with respect to skeleton 416. The controller detects and monitors this motion of platen 412 with respect to skeleton 416, and from this can determine the thickness of a product on lower cooking surface 414. Once this thickness has been determined, the controller can recognize the particular product on surface 414, as each product will have a specific thickness that identifies it. The controller then controls a motor (not shown) to move skeleton 416 (and thus) upper platen 412 to a set position. The controller can then force platen 412 downward onto the food product, thus placing additional pressure on the product being cooked beyond the actual weight of the upper cooking platen weight.

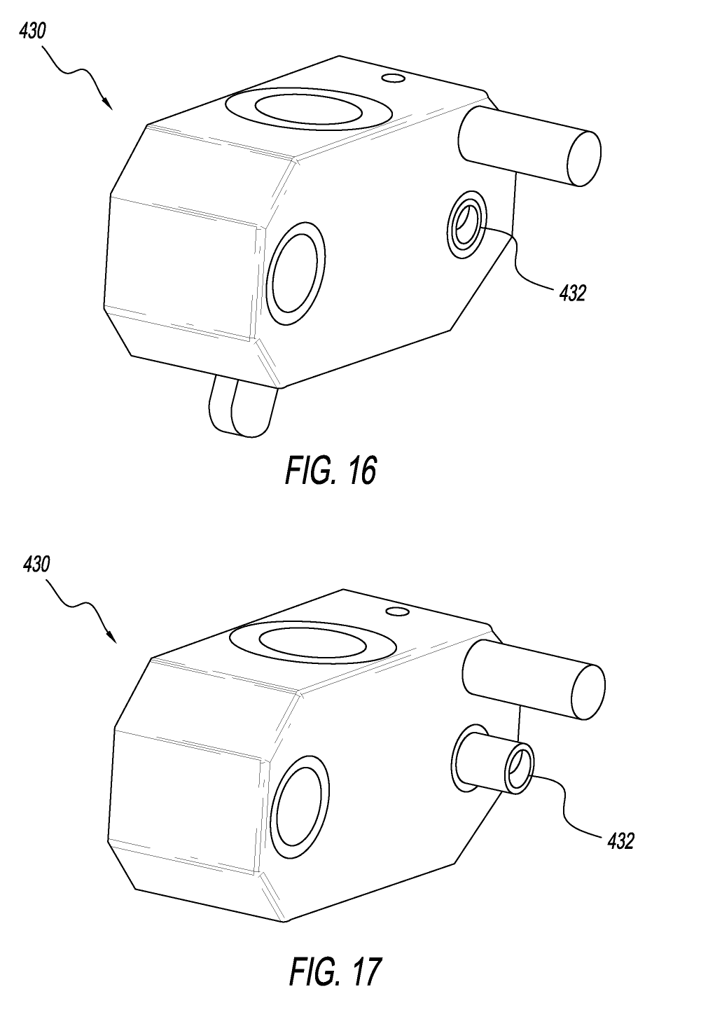

Referring to FIGS. 16 and 17, locking pin mechanism 430 is shown, and has at least one pin 432 thereon. When the controller moves platen 412 and skeleton 416 into a horizontal position that is parallel to cooking surface 414 in the manner described above, pin 432 engages skeleton 416 by mating with a corresponding hole (not shown) on skeleton 416. This locks skeleton 416 in a horizontal position. The controller of grill 410 can then apply pressure to the food product on surface 414 by driving skeleton 416 and platen 412 down onto the product.

In this process, the skeleton structure 416 moves to a set position determined by the controller, based on the desired position corresponding to a specific product. The controller monitors the position of skeleton 416 and platen 412, and the force provided by the motor, to ensure that the force applied to the food product is equal to the weight specified by the customer for the specific product being cooked. The controller also controls the motor to stop the upper platen 412 system at a minimum position or gap specified by the customer for the product being cooked.

Grill 410 thus uses two methods of weight generation for applying pressure to the food product, namely the platen weight and the pressure or force generated by the motor. The controller, in conjunction with the input from a number of sensors (not shown) on grill 410, drives the positioning and lifting motor downward with a specific force that is additive force placed on the food.

In grill 410, since skeleton structure 416 can be locked parallel to lower cooking surface 414, and upper platen 414 can be manipulated to drive a force on the food product that is greater than its weight, the actual weight of platen 414 can be less than what is commonly used. This provides several advantages, most prominently that the stress and demands on the lifting system for the platen is greatly reduced. Grill 410 is also advantageous in that the ability to sense the relative motion between skeleton structure 416 and platen 412 when platen 412 contacts a food product provides the ability to sense a food product height, and go to minimum product gap. The controller can change the weight required to cook the product through the controls without having to change the platen's overall weight. Grill 410 is also more flexible for cooking future products that may require less or more weight on the food product. Lastly, grill 410 can also adjust to an uneven product if necessary.

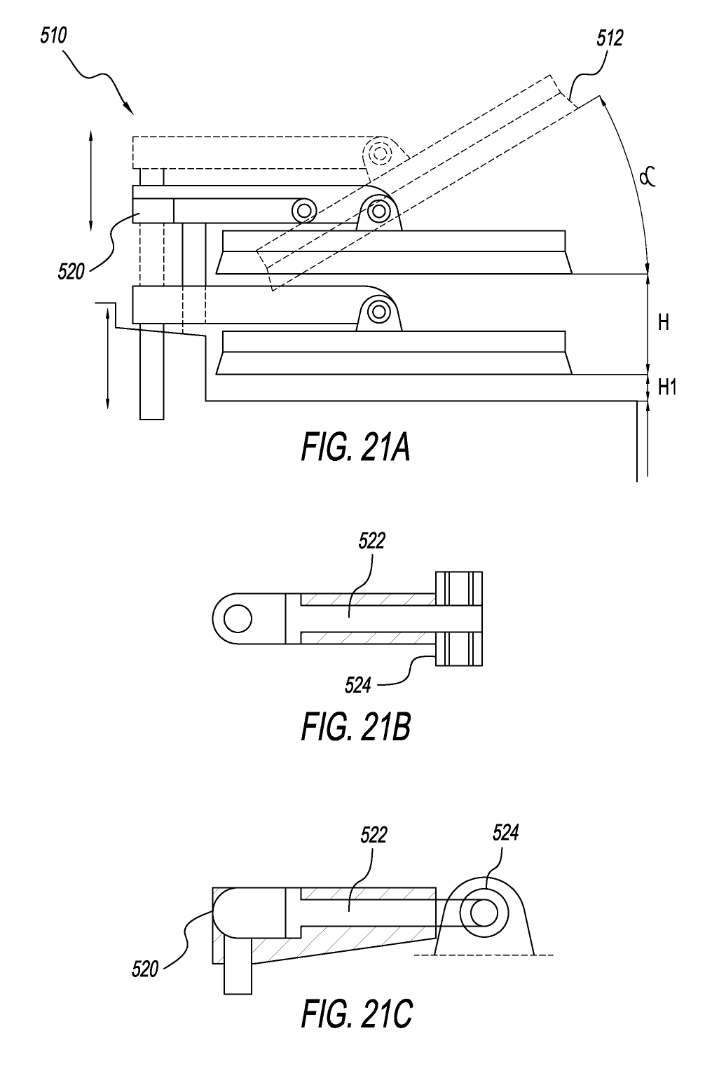

Referring to FIG. 21, grill 510 is shown. Grill 510 has upper platen 512, which is raised from or lowered to a cooking surface (not shown) to cook products thereon. Platen 512 is suspended from a support 520 with a combination of two yokes 522 and 524, which are arranged perpendicularly to one another. Platen 512 is rotatably connected to yoke 524, so that platen 512 can rotate in a front-to-back direction. Yoke 524 is rotatably connected to yoke 522, so that platen 512 can rotate around a longitudinal axis of yoke 522, or in a side-to-side direction. Thus, a controller (not shown) can adjust the position or level of platen 512 automatically, based on the input from sensors (not shown) that detect the position of platen 512. Grill 510 may also have an additional yoke or way to provide a third axis of rotation for platen 512, further improving the amount of control the user will have over positioning.

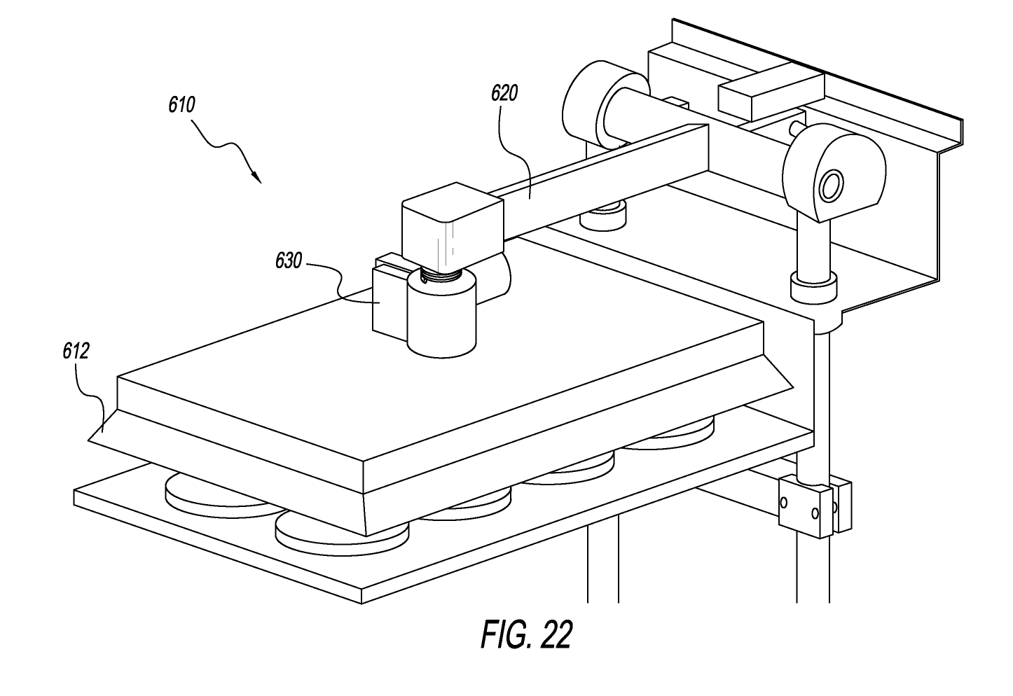

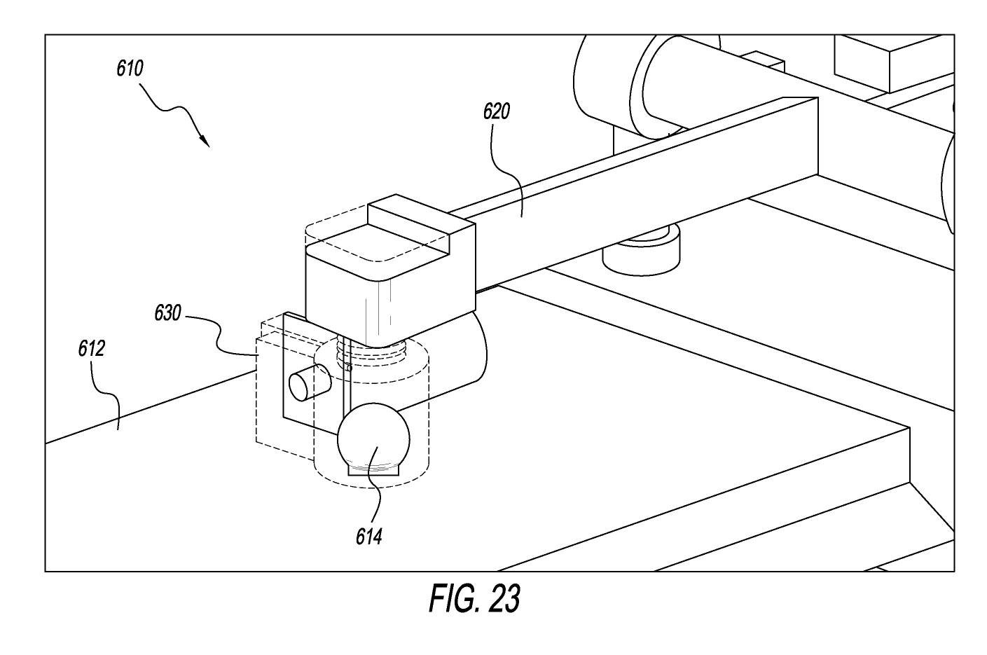

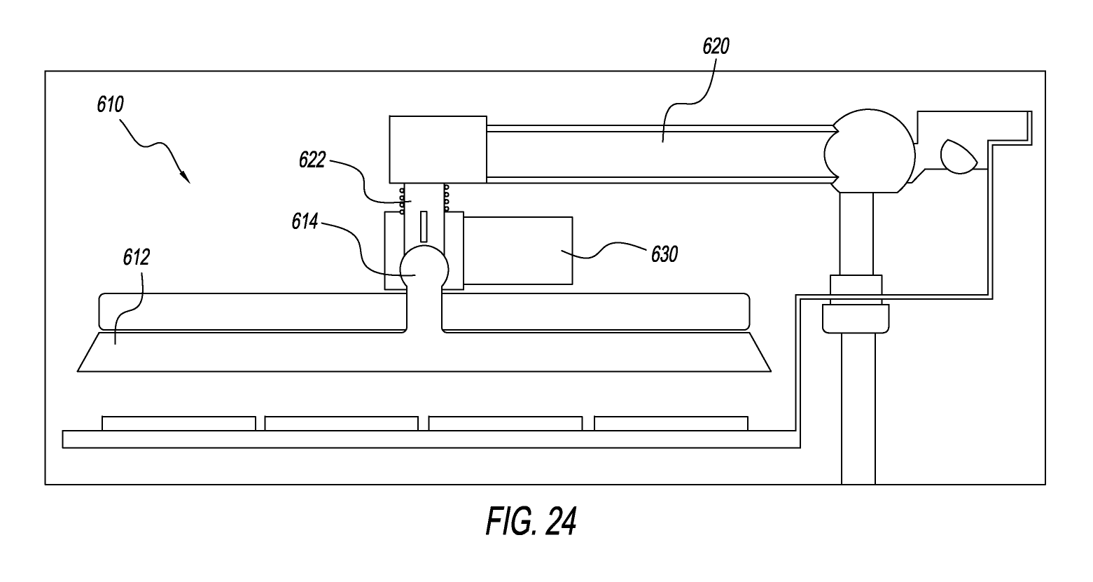

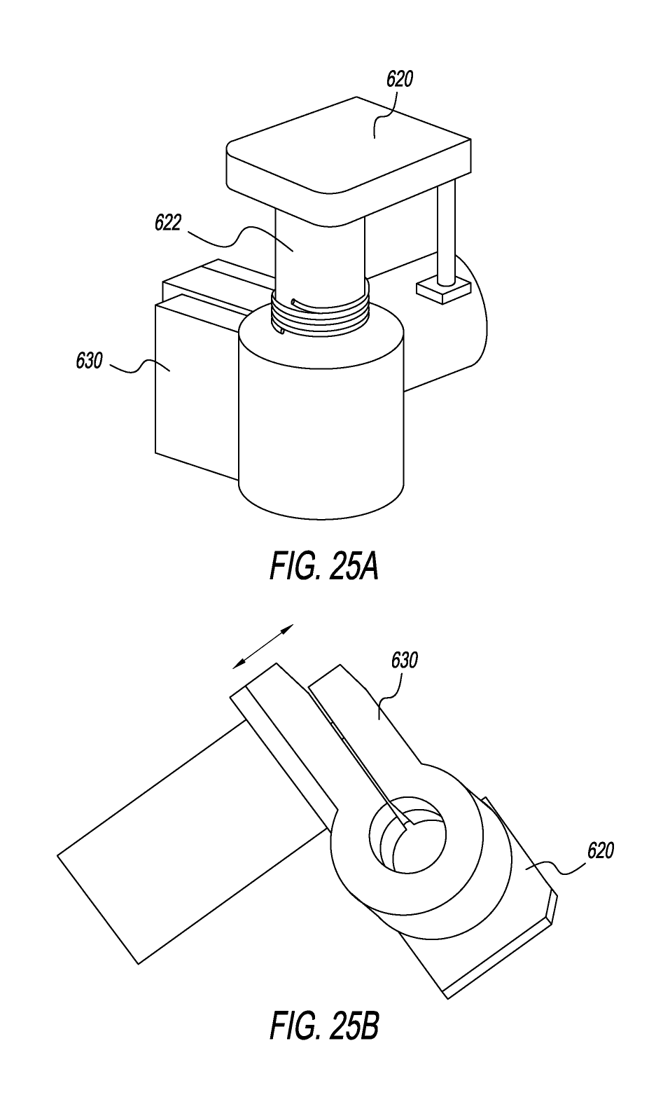

Referring to FIGS. 22-25, grill 610 is shown, which has platen 612, mounting ball 614, support arm 620, and receiver 630. Mounting ball 614 is affixed to a top surface of platen 612.

Support arm 620 has a protrusion 622 extending in a downward direction therefrom, toward the top surface of platen 612. When grill 610 is in used, receiver 630 surrounds mounting ball 614 and protrusion 622, so that receiver 630 connects platen 612 to support arm 620. Receiver 630 has a relief slot 632 therein, which enables receiver 630 to be tightened or loosened around mounting ball 614 as required by a separate device that is automatically controlled (not shown). When receiver 630 is loosened, platen 612 can be adjusted through three axes of motion. Once tightened, receiver 630 restricts motion between platen 612 and support arm 620. Receiver 630 can be tightened with a common mechanical fastener. Alternatively, the tightening force may be applied through a solenoid or other device through the use of a controller and algorithm. Since mounting ball 614 is free to rotate, platen 612 can easily be referenced and adjusted to match the plane of a grill surface below it, enabling an easy way to auto-level or manually level the platen.

In the shown embodiments of grill 610, two-axis and three-axis adjustability are shown, but a simple one-axis adjustment could also be used, if that is all that is required. Mounting ball 614 can alternatively be attached to support arm 620, and receiver 630 attached to platen 612. Receiver 630 can be clamped around the ball in a variety of ways either through human interface, electronic or pneumatic control. Mounting ball 614 and receiver 630 can be designed so that as a coupling, they can be rigidly fixed to support arm 620, or alternatively be able to move along a single axis that is approximately perpendicular to the face of platen 612. In this fashion, the coupling would be said to be floating.

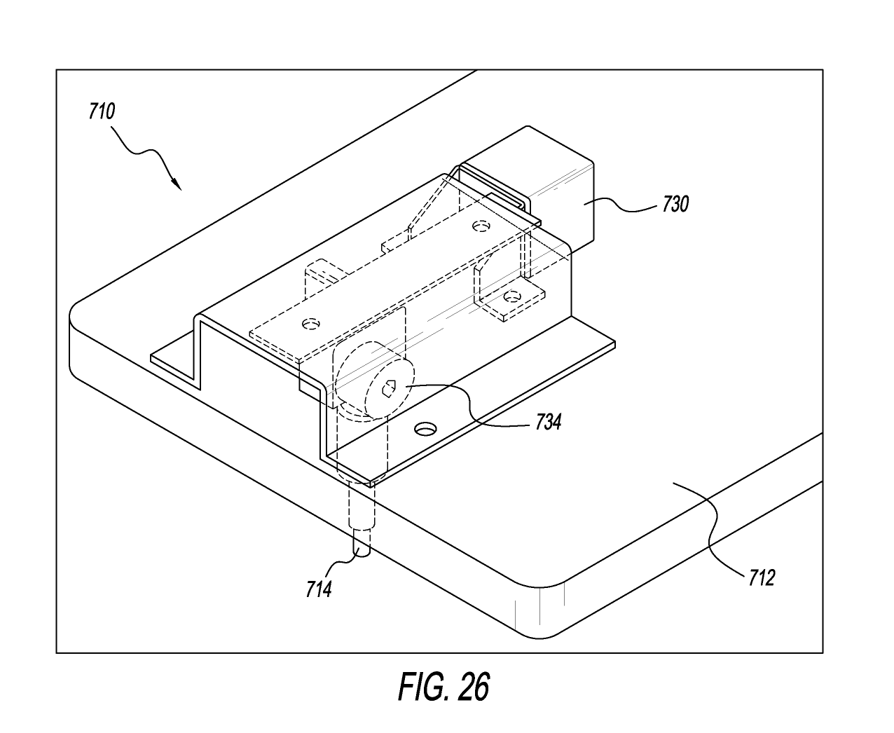

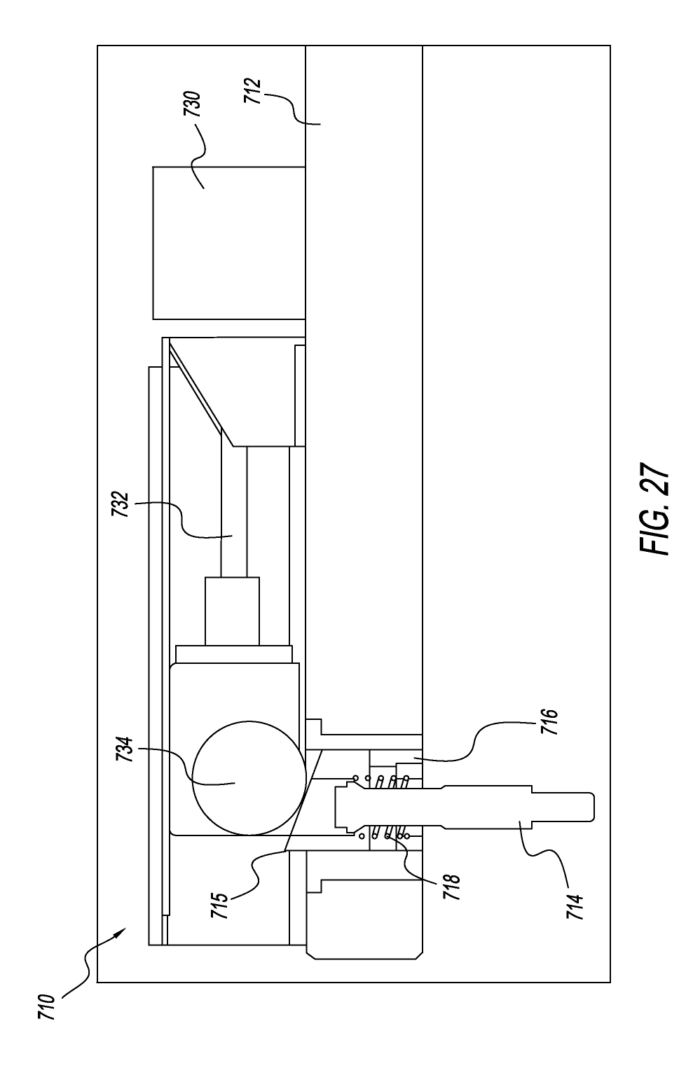

Referring to FIGS. 26 and 27, grill 710 is shown, which has a platen (not shown) and a platen beam 712. Platen beam 712 is separate from the platen itself. The platen will have one or more suspension bolts 714 embedded in a top surface thereof, so that the platen can be mounted or supported from bolts 714. Beam 712 has a bushing 716 and a spring 718 corresponding to each bolt 714. Beam 712 is connected to the top surface of the platen so that bolts 714 slidingly fit within bushing 716, and are spring-loaded by spring 718. The spring force needs to be high enough to exceed the platen weight when the “head support” is unrestricted in the vertical direction. This creates a movable space for bolt 714, and the platen connected thereto, to rise when the platen sits on an object or the grill plate, or to lower when the support is pushed down by a device or mechanism in the manner described below.

In one embodiment, there are three suspension bolts 714. Since the platens are typically rectangular, there can be two bolts 714 at one end of the platen for cross-grill support, and the third bolt 714 at the opposite end of the platen for front-to-back support. Two of bolts 714 can be fixed, meaning that they do not move with respect to a platen beam 712, and one bolt 714, the one used for front-to-back support, can be adjusted in the manner described.

Grill 710 comprises a feedback system that detects when the platen contacts an object or the lower grill surface. When this feedback system indicates that all of the three bolts 714 do not contact the surface essentially simultaneously, it will send a signal to motor 730. Motor 730 can then drive an actuator 732 that pushes a cam 734 into a support 715 that holds bolt 714. This will adjust the height of bolt 714 to a desired amount, which will level platen 712 by matching the condition of the other bolts.

One way to carry out this auto-leveling process is to place one set of sensors (e.g., reed switches and magnets)(not shown) in the proximity of each shoulder bolt 714, or at each end of the long side of the rectangle of platen 712. During a calibration check process (e.g., daily, after the grill is properly cleaned), platen 712 would lower and the sensor switch feedback can be converted to a height value (from the actuator encoder calibration). The differences in these values from the original “zero”, would result in an adjustment of shoulder bolts 714 to realign platen 712 based on the difference in the values. As described above, motor 720 operates on bolt 714 to level platen 712. This adjustment could be confirmed by running another calibration.

FIGS. 26 and 27 show a cam roller 734, but it may also be a wedge type component. Platen 712 can have three or four shoulder bolts 714. The feedback system can be any system which allows for the capture of movement counts against the relative movement between the platen beam and the platen assembly (such as what happens when the grill plate is encountered). Motor 730 could also be any electrical linear drive device

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

What is claimed is:

1. A grill, comprising;
a lower heating plate;
an upper platen having a bottom surface and a top surface, wherein a food product is cooked between said bottom surface and said lower heating plate;
a lever connected to said top surface of said upper platen;
a motor connected to said lever and said top surface of said upper platen; and
a lead screw operably connected to said motor, so that a vertical position of said upper platen is adjusted when said motor acts on said screw.

2. The grill of claim 1, further comprising:
two trunnions, one connected to each end of said lead screw; and
two flexible links, one each connected to an associated trunnion, said lever, and said top surface of said upper platen,
wherein said flexible links adjust said vertical position of said upper platen when said motor acts on said lead screw.

3. The grill of claim 1, further comprising a beam, wherein a first end of said beam is connected to a front end of said lever, and a second end of said beam contacts said lower heating plate, to stabilize said lever and said upper platen.

4. The grill of claim 1, further comprising:
two lead screw wedges, one connected to each end of said lead screw; and
two platen wedges, one each connected to said top surface of said upper platen,
wherein said lead screw wedges and said platen wedges have shapes that generally mate with one another, and
wherein said vertical position of said upper platen is adjusted when said motor acts on said lead screw, forcing said lead screw wedges to engage said platen wedges.

5. The grill of claim 4, further comprising a beam, wherein a first end of said beam is connected to a front end of said lever, and a second end of said beam contacts said lower heating plate, to stabilize said lever and said upper platen.

6. A grill, comprising:
an upper platen;
a cook surface, wherein a food product is cooked between said upper platen and said cook surface;
a rotary actuator; and
a multi-bar linkage system,
wherein said rotary actuator is connected to said upper platen through said multi-bar linkage system, and
wherein said rotary actuator lowers and raises said upper platen in a direction toward and away from said cook surface.

7. The grill of claim 6, wherein said multi-bar linkage system comprises a horizontal lever arm connected to said upper platen, and wherein the grill further comprises a stepper motor operably connected to said upper platen and said lever arm,
wherein said stepper motor adjusts a vertical height of said upper platen with respect to said cook surface.

8. The grill of claim 6, wherein said multi-bar linkage system comprises a mounting bracket for permanently affixing said rotary actuator and said multi-bar linkage system to a mounting surface.

9. A grill, comprising:
a cooking surface;
an upper platen;
a first horizontal vertical member connected to a top surface of said upper platen;
a horizontal member having a first end connected to said first horizontal member;
a pivot about which said horizontal member rotates;
a second vertical member connected to a second end of said horizontal member; and
an actuator operably connected to said second vertical member,
wherein said actuator selectively moves said second vertical member up and down, thereby causing said horizontal member to rotate about said pivot, and in turn adjusting a vertical height of said upper platen with respect to said cooking surface.

10. The grill of claim 10, further comprising a bar having a first end connected to said horizontal arm, and a second end that contacts said cooking surface when said upper platen is lowered beyond a specified height.

11. A grill, comprising:
a cooking surface;
an upper platen;
a skeleton frame connected to a top surface of the upper platen, so that said upper platen can move in a vertical direction with respect to said skeleton frame;
a locking mechanism connected to said skeleton frame, for locking said skeleton frame in a vertical position; and
a control system,
wherein said control system moves said upper platen in a vertical position with respect to said cooking surface, when said skeleton frame is locked in position by said locking mechanism.

12. The grill of claim 11, wherein said locking mechanism comprises a pin that engages with a groove on said skeleton frame, to lock said skeleton frame in place.
